(19) United States
(12) Patent Application Publication
(10) Pub. No.: US 2016/0148225 A1
(43) Pub. Date: May 26, 2016

(54) PRODUCT SALES FORECASTING SYSTEM, METHOD AND NON-TRANSITORY COMPUTER READABLE STORAGE MEDIUM THEREOF

(71) Applicant: INSTITUTE FOR INFORMATION INDUSTRY, Taipei (TW)

(72) Inventors: Tsun KU, Taipei City (TW); Cheng-Hung TSAI, Tainan City (TW); Wen-Tai HSIEH, Taipei City (TW); Ren-Dar YANG, Hsinchu (TW); Hsiao-Chen CHANG, Taipei City (TW)

(21) Appl. No.: 14/558,742

(22) Filed: Dec. 3, 2014

(30) Foreign Application Priority Data
Nov. 24, 2014 (TW) 103140639

(51) Int. Cl. G06Q 30/02

(52) U.S. Cl. CPC G06Q 30/0202

(57) ABSTRACT

A product sales forecasting system and a product sales forecasting method are provided herein. The product sales forecasting method includes: querying for a first relevant product corresponding to a first product in a relevant product database according to the first product, in which the relevant product database stores products and relevant products corresponding to the products respectively; searching for trading record data and comment data corresponding to the first relevant product in an e-commerce platform according to the first relevant product and a price range corresponding to the first relevant product; generating a forecasted consumer volume corresponding to the first product according to the trading record data and the comment data; and generating a forecasted sales volume corresponding to the first product according to the forecasted consumer volume.

### RELEVANT APPLICATIONS

This application claims priority to Taiwan Application Serial Number 103140639, filed, Nov. 24, 2014, which is herein incorporated by reference.

### BACKGROUND

1. Technical Field

The disclosure relates to an e-commerce reputation analysis system and an e-commerce reputation analysis method, and more particularly, to a system and a method for performing an e-commerce reputation analysis according rating data.

2. Description of Related Art

Recently, with the advance of network techniques, the appearance of an e-commerce platform (such as Taobao or JD On-line Shopping Mall, etc.) provides a new consumption pattern to consumers. The consumers may search for and obtain the desired merchandise from many e-commerce platforms merely through Internet connections, thereby making shopping more convenient. Therefore, more and more consumers prefer to use such a consumption pattern to do shopping.

Since the amounts of the consumers who shop in the e-commerce platform have increased substantially, how to effectively forecast a product sales volume from a seller in one e-commerce platform becomes very important. In prior art, it is to perform statistics on the actual sales volume of a product, and the sales volume of the product in the future is forecasted according to the actual sales volume. However, the forecast result of the sales volume of the product in the future is quite inaccurate in this way, and it fails to forecast the sales volume of relevant products corresponding to the product.

Hence, how to provide an effective forecast for the forecasted sales volume of products in the E-commerce platform is an issue desired to be solved by those in this industry.

### SUMMARY

One aspect of the disclosure is to provide a product sales forecasting system. The product sales forecasting system includes a relevant product database, a relevant product query module, a searching module and a forecasting module. The relevant product database is configured to store products and relevant products corresponding to the products respectively. The relevant product query module is configured to query for a first relevant product corresponding to a first product in the relevant product database according to the first product. The searching module is configured to search for trading record data and comment data corresponding to the first relevant product in an e-commerce platform according to the first relevant product and a price range corresponding to the first relevant product. The forecasting module is configured to generate a forecasted consumer volume corresponding to the first product according to the trading record data and the comment data, and configured to generate a forecasted sales volume corresponding to the first product according to the forecasted consumer volume.

In one embodiment, the forecasting module is configured to generate an accumulated sales volume corresponding to the first relevant product according to the trading record data, configured to extract negative comment data from the comment data to generate a negative comment volume, and configured to generate the forecasted consumer volume by subtracting the negative comment volume from the accumulated sales volume.

In one embodiment, the searching module is further configured to search for delivery amounts corresponding to the first relevant product from sellers in the e-commerce platform. The forecasting module is further configured to sum the delivery amounts within a range of a delivery amount ranked list to generate the accumulated sales volume, in which the delivery amount ranked list is ranked according to the delivery amounts corresponding to the first relevant product from the sellers.

In one embodiment, the forecasting module is further configured to determine whether each of the comment data includes at least one of a plurality of negative vocabularies, and configured to set the comment data with the at least one of the negative vocabularies as the negative comment data

In one embodiment, the relevant product database further stores historical sales volumes corresponding to the relevant products respectively. The relevant product query module is further configured to query for a second relevant product corresponding to the first product in the relevant product database according to the first product. The forecasting module is further configured to generate the forecasted sales volume according to the forecasted consumer volume and the historical sales volume corresponding to the second relevant product.

In one embodiment, the forecasting module is configured to calculate the forecasted consumer volume and the historical sales volume corresponding to the second relevant product by Generalized Least Squares (GLS), Discrete Equation, Linear Regression and Nonlinear Regression, or Bezier curve algorithm to generate the forecasted sales volume.

In one embodiment, the searching module is further configured to search for the trading record data and the comment data within a time period corresponding to a forecasted time according to the first relevant product, the price range and the time period. The forecasting module is further configured to generate the forecasted consumer volume within the time period according to the trading record data and the comment data within the time period, and to generate the forecasted sales volume corresponding to the first product in the forecasted time according to the forecasted consumer volume within the time period.

Another aspect of the disclosure is to provide a product sales forecasting method. The product sales forecasting method includes: querying for a first relevant product corresponding to a first product in a relevant product database according to the first product, in which the relevant product database stores products and relevant products corresponding to the products respectively; searching for trading record data and comment data corresponding to the first relevant product in an e-commerce platform according to the first relevant product and a price range corresponding to the first relevant product; generating a forecasted consumer volume corresponding to the first product according to the trading record data and the comment data; and generating a forecasted sales volume corresponding to the first product according to the forecasted consumer volume.

In one embodiment, the step of generating the forecasted consumer volume corresponding to the first product according to the trading record data and the comment data includes: generating an accumulated sales volume corresponding to the first relevant product according to the trading record data; extracting negative comment data from the comment data to generate a negative comment volume; and generating the forecasted consumer volume by subtracting the negative comment volume from the accumulated sales volume.

In one embodiment, the step of generating the accumulated sales volume corresponding to the first relevant product according to the trading record data includes: searching for delivery amounts corresponding to the first relevant product from sellers in the e-commerce platform; and summing the delivery amounts within a range of a delivery amount ranked list to generate the accumulated sales volume, in which the delivery amount ranked list is ranked according to the delivery amounts corresponding to the first relevant product from the sellers.

In one embodiment, the step of extracting the negative comment data from the comment data to generate the negative comment volume includes: determining whether each of the comment data includes at least one of negative vocabularies; and setting the comment data with the at least one of the negative vocabularies as the negative comment data.

In one embodiment, the relevant product database further stores historical sales volumes corresponding to the relevant products respectively. The step of generating the forecasted sales volume corresponding to the first product according to the forecasted consumer volume includes: querying for a second relevant product corresponding to the first product in the relevant product database according to the first product; and generating the forecasted sales volume according to the forecasted consumer volume and the historical sales volume corresponding to the second relevant product.

In one embodiment, the step of generating the forecasted sales volume according to the forecasted consumer volume and the historical sales volume corresponding to the second relevant product includes: calculating the forecasted consumer volume and the historical sales volume corresponding to the second relevant product by Generalized Least Squares (GLS), Discrete Equation, Linear Regression and Nonlinear Regression, or Bezier curve algorithm to generate the forecasted sales volume.

Another aspect of the disclosure is to provide a non-transitory computer readable storage medium for executing a product sales forecasting method. The product sales forecasting method includes: querying for a first relevant product corresponding to a first product in a relevant product database according to the first product, in which the relevant product database stores products and relevant products corresponding to the products respectively; searching for trading record data and comment data corresponding to the first relevant product in an e-commerce platform according to the first relevant product and a price range corresponding to the first relevant product; generating a forecasted consumer volume corresponding to the first product according to the trading record data and the comment data; and generating a forecasted sales volume corresponding to the first product according to the forecasted consumer volume.

### BRIEF DESCRIPTION OF THE DRAWINGS

The disclosure can be more fully understood by reading the following detailed description of the embodiment, with reference made to the accompanying drawings as follows:

FIG. 1 illustrates a schematic block diagram of a product sales forecasting system according to one embodiment of the present disclosure;

FIG. 2 illustrates a flow chart of a product sales forecasting method according to one embodiment of the present disclosure;

FIG. 3 illustrates a flow chart of one step of the product sales forecasting method according to one embodiment of the present disclosure; and

FIG. 4 illustrates a flow chart of another step of the product sales forecasting method according to one embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, although the terms “first,” “second,” etc., may be used herein to describe various elements, these elements should not be limited by these terms. These terms are used to distinguish one element from another, and do not intend to point out a specific order or sequence. For example, a first element could be termed a second element, and, similarly, a second element could be termed a first element, without departing from the scope of the embodiments.

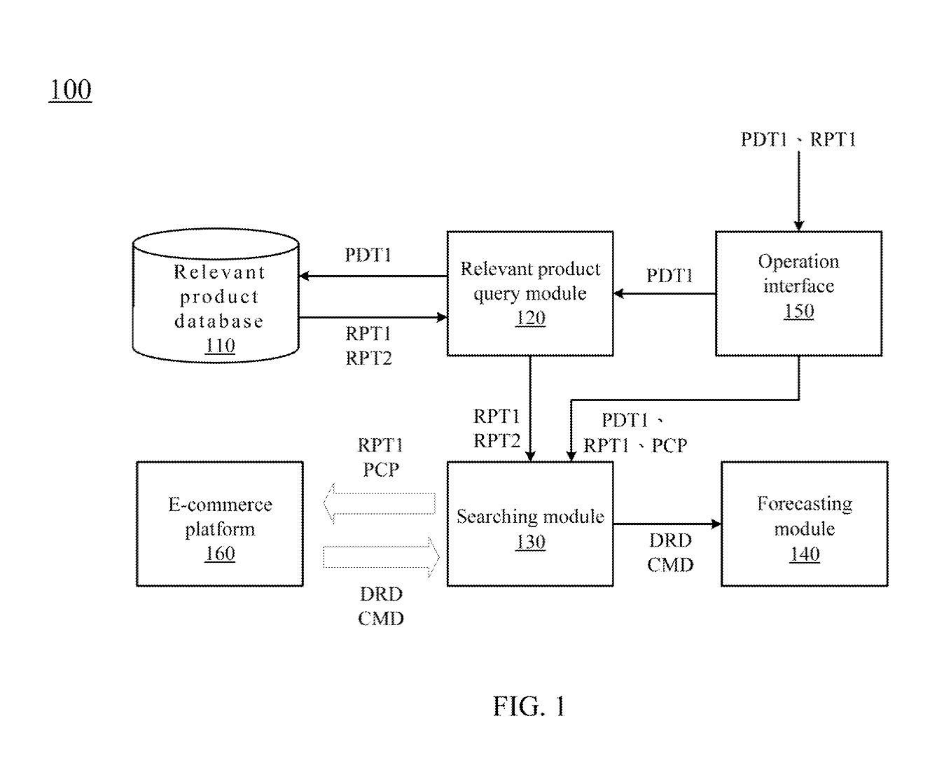

Reference is made to FIG. 1. FIG. 1 illustrates a schematic block diagram of a product sales forecasting system 100 according to one embodiment of the present disclosure. A user may input a product (e.g., a mobile phone case) to the product sales forecasting system 100. The product sales forecasting system 100 can query for a relevant product (e.g., a mobile phone) corresponding to the product according to the product, and forecast a sales volume of the product (i.e., the mobile phone case) that the user is desired to realize according to the relevant product information. As shown in FIG. 1, the product sales forecasting system 100 includes a relevant product database 110, a relevant product query module 120, a searching module 130 and a forecasting module 140. The relevant product database 110 is configured to store several products and several relevant products corresponding to the products respectively. The relevant product query module 120 is configured to query for a first relevant product RPT1 corresponding to a first product PDT1 in the relevant product database 110 according to information of the first product PDT1 (e.g., name, type, specification, etc.) inputted from a user.

In one embodiment, the product sales forecasting system 100 further includes an operation interface 150. The operation interface 150 is for the user to input the first product PDT1. Moreover, the first relevant product RPT1 for which the relevant product query module 120 queries in the relevant product database 110 can be displayed on the operation interface 150, too.

In another embodiment, in addition to obtaining information of the first relevant product RPT1 by querying in the relevant product database 110 according to the first product PDT1, the relevant product query module 120 can directly receive information of the first relevant product RPT1 from the user through the operation interface 150. In other words, the user can select and input the first relevant product RPT1 for forecasting the first product PDT1 according to actual requirements.

In one embodiment, the first product PDT1 can be an accessory product corresponding to the first relevant product RPT1. For example, if it is assumed that the first product PDT1 is a mobile phone case, an earphone or a battery, then the first relevant product RPT1 for which the relevant product query module 120 queries according to the first product PDT1 may be a mobile phone. It is because that when the consumer purchases a mobile phone, the consumer would intend to purchase accessories for the mobile phone, for example, a mobile phone case, an earphone or a battery.

In another embodiment, the first relevant product RPT1 can be a product of the same type as the first product PDT1, e.g., the same type of products of different brands. For example, if it is assumed that the first product PDT1 is a pair of smart glasses manufactured by Google Inc., then the first relevant product RPT1 for which the relevant product query module 120 queries according to the first product PDT1 can be a pair of smart glasses manufactured by Samsung Electronics. It is because that the consumer who purchases the smart glasses may be a hobbyist of it, the consumer who purchases this type of product would intend to further buy the smart glasses of other brands.

The first relevant product RPT1 is related to the first product PDT1. Moreover, the possibility for the consumer to purchase the first product PDT1 would be influenced by the positive/negative comment of the first relevant product RPT1 after purchasing the first relevant product RPT1. Therefore, it is reasonable and effective to use the sales volume and the comments of the first relevant product RPT1 to forecast the forecasted consumer volume of the first product PDT1. The detail will be described in the following embodiments.

The searching module 130 is configured to search for trading record data DRD and comment data CMD corresponding to the first relevant product RPT1 in an e-commerce platform 160 according to the first relevant product RPT1 and a price range corresponding to the first relevant product RPT1. In one embodiment, the e-commerce platform can be an e-shopping platform such as Taobao, Yahoo Auction, JD On-line Shopping Mall, Amazon, etc. In general, the trading record data DRD and the comment data CMD in the e-commerce platform 160 are open and loadable.

Specifically, the e-commerce platform 160 contains a lot of product data. In order for market strategy and increasing the possibility of searching, the product data usually includes extra information. Therefore, if the searching module 130 performs searching in the e-commerce platform 160 only according to the first relevant product RPT1 information (e.g., name, type, etc.), the searching module 130 may find lots of products unrelated to the first relevant product RPT1, such that the searching result is inaccurate. For example, if it is assumed that the first relevant product RPT1 is a mobile phone. When the searching module 130 search the mobile phone in the e-commerce platform 160, in addition to the mobile phone, the searching module 130 may further find accessories corresponding to the mobile phone such as a mobile phone case, an earphone, a battery, etc. However, this product information (e.g., accessories) is not a result that the searching module 130 wants to search for. Therefore, when the searching module 130 performs searching according to the first relevant product RPT1, the user can further input a price range corresponding to the first relevant product RPT1 through the operation interface 150, thereby filtering out unnecessary information. For example, if it is assumed that the first relevant product RPT1 is a mobile phone. Since the price of the mobile phone is substantially larger than the price of the accessory, the searching module 130 can filter out lots of accessories of the mobile phone when it performs searching for the mobile phone in the e-commerce platform 160 according to the price range corresponding to the mobile phone.

The forecasting module 140 is configured to generate a forecasted consumer volume corresponding to the first product PDT1 according to the trading record data DRD and the comment data CMD. Next, the forecasting module 140 is configured to generate a forecasted sales volume corresponding to the first product PDT1 according to the forecasted consumer volume.

In one embodiment, the forecasting module 140 can perform a full text search for the first relevant product RPT1 in the e-commerce platform 160, and extract the trading record data DRD and the comment data CMD corresponding to the first relevant product RPT1 by parsing.

In one embodiment, the forecasting module 140 is configured to generate an accumulated sales volume corresponding to the first relevant product RPT1 according to the trading record data DRD. The forecasting module 140 is further configured to extract negative comment data from the comment data CMD to generate a negative comment volume. Next, the forecasting module 140 can generate the forecasted consumer volume by subtracting the negative comment volume from the accumulated sales volume.

Specifically, if the user wants to forecast a sales volume of a mobile phone case (i.e., the first product PDT1), the first relevant product RPT1 for which the relevant product query module 120 queries may be a mobile phone. If the consumer purchases the mobile phone, then he may make comments on it. If the comment which the consumer makes is good or nothing, it may represent that the consumer is satisfied with the mobile phone. Accordingly, the consumer may further purchase the accessories corresponding to the mobile phone (e.g., the mobile phone case, the earphone, the battery, etc.) If the comment which the consumer makes is bad, it may represent that the consumer is of the opinion that the mobile phone has defects, such that the possibility for the consumer to purchase the accessories corresponding to the mobile phone is decreased. Therefore, the forecasted consumer volume corresponding to the first product PDT1 (e.g., the mobile phone case) can be obtained by subtracting the negative comment volume corresponding to the first relevant product RPT1 (e.g., the mobile phone) from the accumulated sales volume corresponding to the first relevant product RPT1.

In one embodiment, the searching module 130 is further configured to search for delivery amounts corresponding to the first relevant product RPT1 from sellers in the e-commerce platform 160. The forecasting module 140 is further configured to sum the delivery amounts within a range of a delivery amount ranked list to generate the accumulated sales volume. The delivery amount ranked list is ranked according to the delivery amounts corresponding to the first relevant product RPT1 from the sellers.

Specifically, the forecasting module 140 can perform ranking on delivery amounts from sellers within the searching results corresponding to the first relevant product RPT1 in the e-commerce platform 160, so as to generate the delivery amount ranked list. Next, the forecasting module 140 can sum the delivery amounts from the sellers within a range of the delivery amount ranked list (e.g., within the top 300 delivery amounts), so as to generate the accumulated sales volume. Since amounts on the final list of the delivery amount ranked list are substantially less than amounts within the top ranks of the delivery amount ranked list, the delivery amounts on the final list of the delivery amount ranked list (i.e., the delivery amounts beyond the range of a delivery amount ranked list) can be neglected when calculating the accumulated sales volume corresponding to the first relevant product RPT1. Accordingly, the efficiency of calculating the accumulated sales volume corresponding to the first relevant product RPT1 can be increased.

In one embodiment, the forecasting module 140 is further configured to determine whether each of the comment data CMD includes at least one of negative vocabularies, and configured to set the comment data with the at least one of the negative vocabularies as the negative comment data.

Specifically, the forecasting module 140 can perform sentiment analysis on each of the comment data CMD, so as to extract emotional vocabulary (e.g., good, bad, no problem, etc.). Furthermore, the forecasting module 140 can analyze each of the comment data CMD through natural language processing, word analysis and emotional word analysis, and generate keywords including emotion and reputation. Next, the forecasting module 140 can automatically duster on hypemym of matching between themes and emotions, and automatically build a reputation lexical database according to the reputation of the consumer and emotional phrase structure. Accordingly, the forecasting module 140 can effectively depart the text with negative comment from the comment data.

Next, the forecasting module 140 can further compare the keywords with negative vocabularies (e.g., bad, worse, etc.) in a built-in negative comment lexical database, so as to determine whether the comment data includes the negative vocabulary. If one of the comment data includes at least one of the negative vocabularies, the forecasting module 140 sets the one of the comment data as the negative comment data. Accordingly, the forecasting module 140 can extract negative comment data from the comment data CMD as the negative comment data, and performs statistics on the negative comment data.

In one embodiment, the relevant product database 110 further stores historical sales volumes corresponding to the relevant products respectively. The historic sales volume can be a sales record statistics of one of the relevant products in the past (e.g., each year, each month or each day in the past). Accordingly, the relevant product query module 120 is further configured to query for a second relevant product RPT2 corresponding to the first product PDT1 in the relevant product database 110 according to the first product PDT1. The forecasting module 140 is further configured to generate the forecasted sales volume according to the forecasted consumer volume corresponding to the first product PDT1 and the historical sales volume corresponding to the second relevant product RPT2.

In one embodiment, the second relevant product RPT2 can be a previous generation product corresponding to the first product PDT1. For example, if it is assumed that the first product PDT1 is an iPhone 6, then the second relevant product RPT2 can be an iPhone 5s or an iPhone 5. Since the consumer who purchases the iPhone 5s or iPhone 5 may be a hobbyist of Apple Inc., the consumer who purchases this type of product would intend to further buy the iPhone 6. Accordingly, the forecasting module 140 can forecast the sales volume of the iPhone 6 according to the forecasted consumer volume corresponding to the iPhone 6 (i.e., the first product PDT1) and the historical sales volume corresponding to the iPhone 5s (i.e., the previous generation product corresponding to the first product PDT1).

Furthermore, after obtaining the historical sales volume corresponding to the second relevant product RPT2, the forecasting module 140 can perform statistics on the historical sales volume corresponding to the second relevant product RPT2 and generate a sales distribution curve according to the statistics. Next, the forecasting module 140 can perform curve-fitting on the forecasted consumer volume corresponding to the first product PDT1 and the sales distribution curve to obtain the forecasted sales volume corresponding to the first product PDT1. Curve-fitting includes any one of Generalized Least Squares (GLS), Discrete Equation, Linear Regression and Nonlinear Regression, or Bezier curve algorithm. In other words, the forecasting module 140 can calculate the forecasted consumer volume and the historical sales volume corresponding to the second relevant product RPT2 by Generalized Least Squares (GLS), Discrete Equation, Linear Regression and Nonlinear Regression, or Bezier curve algorithm to generate the forecasted sales volume.

In another embodiment, the second relevant product RPT2 can be a product of the same type as the first product PDT1, e.g., the same type of products of different brands. For example, if it is assumed that the first product PDT1 is a smart watch manufactured by Apple Inc., the second relevant product RPT2 can be a smart watch manufactured by Samsung Electronics. Since the consumer who purchases the smart watch may be a hobbyist of it, the consumer who purchases this type of product would intend to further buy the smart watch of other brands. Accordingly, the forecasting module 140 can forecast the sales volume of the smart watch manufactured by Apple Inc. according to the forecasted consumer volume corresponding to the smart watch manufactured by Apple Inc. (i.e., the first product PDT1) and the historical sales volume corresponding to the smart watch manufactured by Samsung Electronics (i.e., the product of the same type as the first product PDT1).

Similarly, after obtaining the historical sales volume corresponding to the second relevant product RPT2, the forecasting module 140 can calculate the forecasted consumer volume and the historical sales volume corresponding to the second relevant product RPT2 by Generalized Least Squares (GLS), Discrete Equation, Linear Regression and Nonlinear Regression, or Bezier curve algorithm to generate the forecasted sales volume. The detail is described in the aforementioned embodiments, and thus they are not further detailed herein.

Accordingly, the product sales forecasting system 100 can effectively forecast the sales volume of the first product PDT1 inputted from the user by the aforementioned embodiments. The forecasted sales volume is not generated only by performing statistics on the comments amounts or the delivery amounts of the first product PDT1 in the e-commerce platform. The forecasted sales volume of the first product PDT1 is generated by forecasting the volume of the consumers who would purchase the first product PDT1 and performing curve fitting on the historical sales volume corresponding to the relevant products and the forecasted consumer volume corresponding to the first product PDT1. Therefore, the forecasted sales volume corresponding to the first product PDT1 is more accurate.

In one embodiment, the product sales forecasting system can further forecast the sales volume of the first product PDT1 in a forecasted time (e.g., in a week, in a month, etc.). Specifically, the user can input a desired forecasted time through the operation interface 150. The searching module 130 is further configured to search for the trading record data and the comment data within a time period corresponding to the forecasted time (e.g., a week, a month, etc.) according to the first relevant product RPT1, the price range PCP and the time period. The forecasting module 140 is further configured to generate the forecasted consumer volume within the time period according to the trading record data and the comment data within the time period, and to generate the forecasted sales volume corresponding to the first product PDT1 in the forecasted time according to the forecasted consumer volume within the time period.

For example, if it is assumed that the user wants to forecast the sales volume of an iPhone 6 case in a month, then the length of the time period is one month. The searching module 130 can search for the trading record data and the comment data within the time period (e.g., one month in the past) according to the first relevant product RPT1, the price range PCP and the time period. The forecasting module 140 can generate the forecasted consumer volume within the time period according to the trading record data and the comment data within the time period, and generate the forecasted sales volume corresponding to the first product PDT1 in the forecasted time (i.e., in a month) according to the forecasted consumer volume within the time period.

Moreover, the sales volume of a product forecasted by the product forecasting system 100 is not limited in one e-commerce platform. In other words, the product forecasting system 100 can search for the trading record data and the comment data in lots of e-commerce platforms (e.g., searching in Taobao and JD On-line Shopping Mall simultaneously), and generate a total forecasted consumer volume corresponding to the first product PDT1 according to all trading record data and all comment data in e-commerce platforms. Next, the product forecasting system 100 can generate a total forecasted sales volume correspond to the first product PDT1 according to the total forecasted consumer volume, that is, all forecasted sales volumes corresponding to the first product PDT1 in all e-commerce platforms.

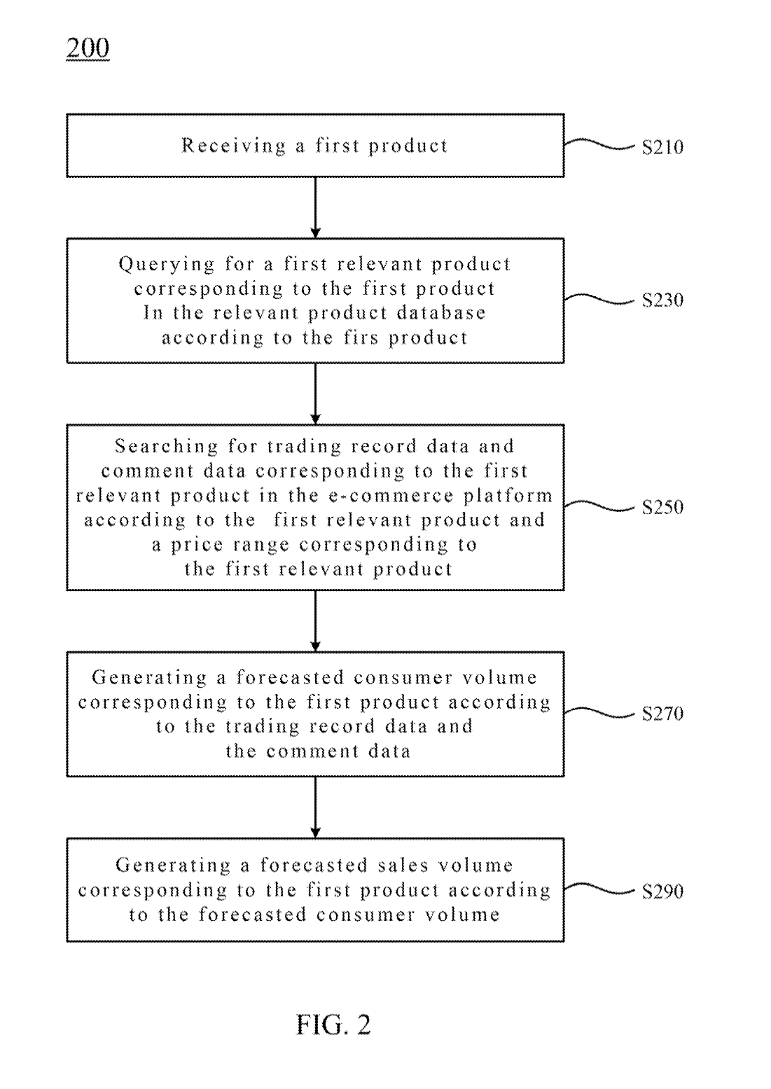

Reference is made to FIG. 2. FIG. 2 illustrates a flow chart of a product sales forecasting method 200 according to one embodiment of the present disclosure. The product sales forecasting method 200 can be implemented as a computer program product (such as a computer program), and stored in a computer-readable recording medium. After loading in the computer-readable recording medium, a computer performs the e-commerce reputation analysis method 200. The machine-readable medium can be, but is not limited to, a floppy diskette, an optical disk, a compact disk-read-only memory (CD-ROM), a magneto-optical disk, a read-only memory (ROM), a random access memory (RAM), an erasable programmable read-only memory (EPROM), an electrically erasable programmable read-only memory (EEPROM), a magnetic or optical card, a flash memory, a network accessible library or another type of media/machine-readable medium suitable for storing electronic instructions.

In order to describe the product sales forecasting method 200 clearly, the product sales forecasting method 200 of FIG. 2 is described with the product sales forecasting system 100 of FIG. 1, but the present disclosure is not limited in this regard.

As shown in FIG. 2, at first, in operation S210, a first product PDT inputted from a user is received through the operation interface 150. Next, in operation S230, a first relevant product RPT1 corresponding to the first product PDT1 is queried in the relevant product database 110. Next, in operation S250, trading record data DRD and comment data CMD corresponding to the first relevant product RPT1 are searched in the e-commerce platform 160 according to the first relevant product RPT1 and a price range PCP corresponding to the first relevant product RPT1. Next, in operation S270, a forecasted consumer volume corresponding to the first product PDT1 is generated according to the trading record data DRD and the comment data CMD. Next, in operation S290, a forecasted sales volume corresponding to the first product PDT1 is generated according to the forecasted consumer volume.

In one embodiment, the first product PDT1 can be an accessory product corresponding to the first relevant product RPT1. In another embodiment, the first product PDT1 can be a product of the same type as the first relevant product RPT1, e.g., the same type of the products of different brands. The detail is described in the aforementioned embodiments, and thus they are not further detailed herein.

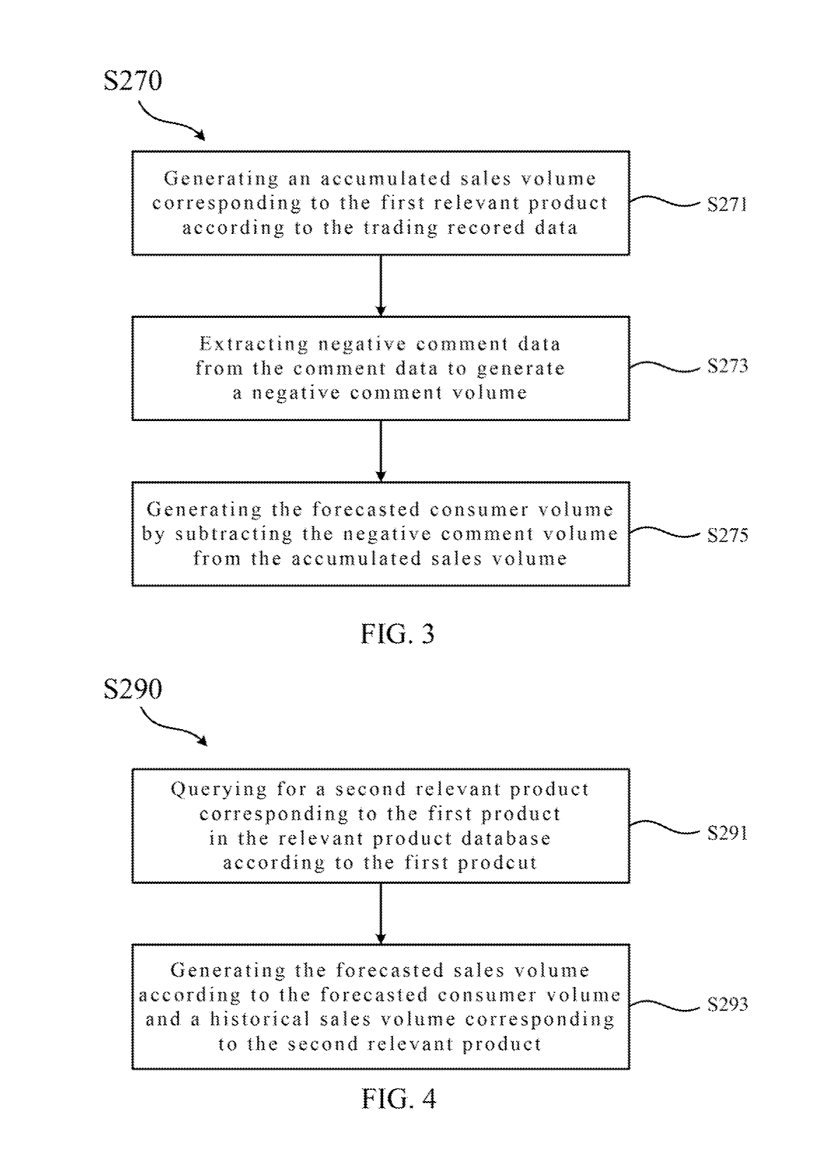

In one embodiment, operation S270 further includes operations S271-S275. Reference is made to FIG. 3. FIG. 3 illustrates a flow chart of one step S270 of the product sales forecasting method 200 according to one embodiment of the present disclosure. As shown in FIG. 3, at first, in operation S271, an accumulated sales volume corresponding to the first relevant product RPT1 is generated according to the trading record data DRD. Specifically, operation S271 further includes: searching for delivery amounts corresponding to the first relevant product RPT1 from sellers in the e-commerce platform 160; and summing the delivery amounts within a range of a delivery amount ranked list to generate the accumulated sales volume, in which the delivery amount ranked list is ranked according to the delivery amounts corresponding to the first relevant product RPT1 from the sellers. The detail is described in the aforementioned embodiments, and thus they are not further detailed herein.

Next, in operation S273, negative comment data are extracted from the comment data CMD to generate a negative comment volume. Specifically, operation S273 further includes: determining whether each of the comment data includes at least one of negative vocabularies; and setting the comment data with the at least one of the negative vocabularies as the negative comment data. The detail is described in the aforementioned embodiments, and thus they are not further detailed herein.

Next, in operation S275, the forecasted consumer volume corresponding to the first product PDT1 is generated by subtracting the negative comment volume from the accumulated sales volume.

In one embodiment, operation S290 further includes operations S291-S293. Reference is made to FIG. 4. FIG. 4 illustrates a flow chart of another step S290 of the product sales forecasting method 200 according to one embodiment of the present disclosure. As shown in FIG. 4, at first, in operation S291, a second relevant product RPT2 corresponding to the first product PDT1 is queried in the relevant product database 110 according to the first product PDT1.

Next, in operation S293, the forecasted sales volume is generated according to the forecasted consumer volume and a historical sales volume corresponding to the second relevant product RPT2. In one embodiment, the forecasted sales volume is generated by calculating the forecasted consumer volume and the historical sales volume corresponding to the second relevant product RPT2 through Generalized Least Squares (GLS), Discrete Equation, Linear Regression and Nonlinear Regression, or Bezier curve algorithm. The detail is described in the aforementioned embodiments, and thus they are not further detailed herein.

In one embodiment, the second relevant product RPT2 can be a previous generation product corresponding the first product PDT1. In another embodiment, the second relevant product RPT2 can be a product of the same type as the first product PDT1, e.g., the same type of products of different brands. The detail is described in the aforementioned embodiments, and thus they are not further detailed herein.

As mentioned above, the product sales forecasting system 100 or the product sales forecasting method 200 may be implemented in terms of software, hardware and/or firmware. For instance, if the execution speed and accuracy have priority, the product sales forecasting system 100 may be implemented in terms of hardware and/or firmware. If the design flexibility has higher priority, then the product sales forecasting system 100 may be implemented in terms of software. Furthermore, the product sales forecasting system 100 may be implemented in terms of software, hardware and firmware in the same time. It is noted that the foregoing examples or alternates should be treated equally, and the present disclosure is not limited to these examples or alternates. Anyone who is skilled in the prior art can make modification to these examples or alternates in flexible way if necessary.

As mentioned above, the sales volume of the first product PDT1 inputted from the user can be forecasted effectively by the product sales forecasting system 100 and the product sales forecasting method 200. The forecasted sales volume is not generated only by performing statistics on the comments amounts or the delivery amounts of the first product PDT1 in the e-commerce platform. The forecasted sales volume of the first product PDT1 is generated by forecasting the volume of the consumers who would purchase the first product PDT1 and performing curve fitting on the historical sales volume corresponding to the relevant products and the forecasted consumer volume corresponding to the first product PDT1. Therefore, the forecasted sales volume corresponding to the first product PDT1 is more accurate.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A product sales forecasting system, comprising:
a relevant product database configured to store a plurality of products and a plurality of relevant products corresponding to the products respectively;
a relevant product query module configured to query for a first relevant product corresponding to a first product in the relevant product database according to the first product;
a searching module configured to search for a plurality of trading record data and a plurality of comment data corresponding to the first relevant product in an e-commerce platform according to the first relevant product and a price range corresponding to the first relevant product; and
a forecasting module configured to generate a forecasted consumer volume corresponding to the first product according to the trading record data and the comment data, and configured to generate a forecasted sales volume corresponding to the first product according to the forecasted consumer volume.

2. The product sales forecasting system of claim 1, wherein the forecasting module is configured to generate an accumulated sales volume corresponding to the first relevant product according to the trading record data, configured to extract a plurality of negative comment data from the comment data to generate a negative comment volume, and configured to generate the forecasted consumer volume by subtracting the negative comment volume from the accumulated sales volume.

3. The product sales forecasting system of claim 2, wherein the searching module is further configured to search for a plurality of delivery amounts corresponding to the first relevant product from a plurality of sellers in the e-commerce platform, and the forecasting module is further configured to sum the delivery amounts within a range of a delivery amount ranked list to generate the accumulated sales volume, wherein the delivery amount ranked list is ranked according to the delivery amounts corresponding to the first relevant product from the sellers.

4. The product sales forecasting system of claim 2, wherein the forecasting module is further configured to determine whether each of the comment data comprises at least one of a plurality of negative vocabularies, and configured to set the comment data with the at least one of the negative vocabularies as the negative comment data.

5. The product sales forecasting system of claim 1, wherein the relevant product database further stores a plurality of historical sales volumes corresponding to the relevant products respectively, the relevant product query module is further configured to query for a second relevant product corresponding to the first product in the relevant product database according to the first product, and the forecasting module is further configured to generate the forecasted sales volume according to the forecasted consumer volume and the historical sales volume corresponding to the second relevant product.

6. The product sales forecasting system of claim 5, wherein the second relevant product is a previous generation product corresponding to the first product.

7. The product sales forecasting system of claim 5, wherein the second relevant product is a product of the same type as the first product.

8. The product sales forecasting system of claim 5, wherein the forecasting module is configured to calculate the forecasted consumer volume and the historical sales volume corresponding to the second relevant product by Generalized Least Squares (GLS), Discrete Equation, Linear Regression and Nonlinear Regression, or Bezier curve algorithm to generate the forecasted sales volume.

9. The product sales forecasting system of claim 1, wherein the searching module is further configured to search for the trading record data and the comment data within a time period corresponding to a forecasted time according to the first relevant product, the price range and the time period, the forecasting module is further configured to generate the forecasted consumer volume within the time period according to the trading record data and the comment data within the time period, and to generate the forecasted sales volume corresponding to the first product in the forecasted time according to the forecasted consumer volume within the time period.

10. The product sales forecasting system of claim 1, wherein the first product is an accessory product corresponding to the first relevant product.

11. The product sales forecasting system of claim 1, further comprising an operation interface for a user to input the first product, and configured to display the first relevant product.

12. A product sales forecasting method, comprising:
querying for a first relevant product corresponding to a first product in a relevant product database according to the first product, wherein the relevant product database stores a plurality of products and a plurality of relevant products corresponding to the products respectively;
searching for a plurality of trading record data and a plurality of comment data corresponding to the first relevant product in an e-commerce platform according to the first relevant product and a price range corresponding to the first relevant product;
generating a forecasted consumer volume corresponding to the first product according to the trading record data and the comment data; and
generating a forecasted sales volume corresponding to the first product according to the forecasted consumer volume.

13. The product sales forecasting method of claim 12, wherein generating the forecasted consumer volume corresponding to the first product according to the trading record data and the comment data comprises:
generating an accumulated sales volume corresponding to the first relevant product according to the trading record data;
extracting a plurality of negative comment data from the comment data to generate a negative comment volume; and
generating the forecasted consumer volume by subtracting the negative comment volume from the accumulated sales volume.

14. The product sales forecasting method of claim 13, wherein generating the accumulated sales volume corresponding to the first relevant product according to the trading record data comprises:
searching for a plurality of delivery amounts corresponding to the first relevant product from a plurality of sellers in the e-commerce platform; and
summing the delivery amounts within a range of a delivery amount ranked list to generate the accumulated sales volume, wherein the delivery amount ranked list is ranked according to the delivery amounts corresponding to the first relevant product from the sellers.

15. The product sales forecasting method of claim 13, wherein extracting the negative comment data from the comment data to generate the negative comment volume comprises:
determining whether each of the comment data comprises at least one of a plurality of negative vocabularies; and
setting the comment data with the at least one of the negative vocabularies as the negative comment data.

16. The product sales forecasting method of claim 12, wherein the relevant product database further stores a plurality of historical sales volumes corresponding to the relevant products respectively, wherein generating the forecasted sales volume corresponding to the first product according to the forecasted consumer volume comprises:
querying for a second relevant product corresponding to the first product in the relevant product database according to the first product; and
generating the forecasted sales volume according to the forecasted consumer volume and the historical sales volume corresponding to the second relevant product.

17. The product sales forecasting method of claim 16, wherein the second relevant product is a previous generation product corresponding to the first product.

18. The product sales forecasting method of claim 16, wherein the second relevant product is a product of the same type as the first product.

19. The product sales forecasting method of claim 16, wherein generating the forecasted sales volume according to the forecasted consumer volume and the historical sales volume corresponding to the second relevant product comprises:
calculating the forecasted consumer volume and the historical sales volume corresponding to the second relevant product by Generalized Least Squares (GLS), Discrete Equation, Linear Regression and Nonlinear Regression, or Bezier curve algorithm to generate the forecasted sales volume.

20. A non-transitory computer readable storage medium for executing a product sales forecasting method, the product sales forecasting method comprising:
querying for a first relevant product corresponding to a first product in a relevant product database according to the first product, wherein the relevant product database stores a plurality of products and a plurality of relevant products corresponding to the products respectively;
searching for a plurality of trading record data and a plurality of comment data corresponding to the first relevant product in an e-commerce platform according to the first relevant product and a price range corresponding to the first relevant product;
generating a forecasted consumer volume corresponding to the first product according to the trading record data and the comment data; and
generating a forecasted sales volume corresponding to the first product according to the forecasted consumer volume.
